(19) United States
(12) Patent Application Publication
(10) Pub. No.: US 2026/0285573 A1
(43) Pub. Date: Sep. 24, 2026

(54) VACUUM SEALING BAG

(71) Applicant: Guangdong Willing Technology Corporation, Huizhou (CN)

(72) Inventor: Changqing Ye, Huizhou (CN)

(21) Appl. No.: 19/209,910

(22) Filed: May 16, 2025

(30) Foreign Application Priority Data
Mar. 18, 2025 (CN) 202520492512.8
Apr. 2, 2025 (CN) 202520623897.7

(51) Int. Cl. B65D 81/20; B29C 49/00; B29K 23/00; B29L 31/00; B65D 33/01

(52) U.S. Cl. CPC B65D 81/2023; B29C 49/0005; B65D 33/01; B29K 2023/06; B29K 2023/12; B29K 2995/0074; B29K 2995/0097; B29L 2031/7129

(57) ABSTRACT

Disclosed is a vacuum sealing bag, including a bag body, wherein the bag body comprises a wall body formed of plastic film, a bag mouth formed at a top of the wall body, and a bag bottom axially opposite to the bag mouth; the wall body is a circumferentially closed continuous surface structure, and an inner surface thereof encloses to form a vacuum accommodation cavity; the inner surface of the wall body is provided with a functional raised-and-depressed texture, wherein the raised-and-depressed texture extends continuously from the bag mouth along the inner surface of the wall body to the bag bottom to form a gas discharge path; and the bag mouth is heat-sealable.

### CROSS REFERENCE TO RELATED APPLICATIONS

The present disclosure claims the priority of Chinese Patent Application No. 2025204925128 filed on Mar. 18, 2025 before CNIPA, and Chinese Patent Application No. 2025206238977 filed on Apr. 2, 2025 before CNIPA. All the above are hereby incorporated by reference in their entirety.

### TECHNICAL FIELD

The present disclosure relates to the technical field of vacuum packaging, and more particularly to a vacuum sealing bag with a circumferentially closed continuous surface structure.

### BACKGROUND

A vacuum sealer achieves long-term preservation of articles through two core processes: vacuum evacuation and heat sealing. The working procedure includes: Step 1, Vacuum evacuation: Place the vacuum sealing bag in a sealing chamber, activate a vacuum pump to evacuate air from the bag until reaching a preset pressure or time threshold; Step 2, Heat sealing: Momentarily fuse a double-layer film at the bag mouth (e.g., PA/PE composite material) using a heating element to form a hermetic seal.

To achieve effective air evacuation, conventional vacuum sealing bags require arrangement of a raised-and-depressed texture structure in the bag mouth region to prevent interlayer adhesion of films from blocking gas channels. The structure of sealing bags of the prior art is as shown in FIGS. 1-3, including the following components:

Smooth plastic film layer 0111: provides basic sealing performance and mechanical strength;

Raised-and-depressed texture plastic film layer 0112: the inner wall of the raised-and-depressed texture plastic film layer 0112 is provided with a raised-and-depressed texture 04, with gaps between adjacent raised-and-depressed texture plastic film layers 0112 forming a gas discharge path;

Fusion edge 06: bonds edges of the two film layers through thermocompression to form the bag body;

The smooth plastic film layer 0111 and the raised-and-depressed texture plastic film layer 0112 are connected via the fusion edge 06, with their inner surfaces enclosing to form a vacuum accommodation cavity 015.

Vacuum sealing bags of the prior art have the following drawbacks:
1. Complex multi-step manufacturing process: Requires separate preparation of smooth films and raised-and-depressed texture films, involving multiple independent processes including cutting, lamination, and edge fusion, resulting in high equipment investment and labor costs;
2. Low material utilization rate: Simultaneous processing of two film rolls tends to generate increased edge waste due to uneven tension;

The aforementioned issues result in persistently high production costs for conventional vacuum sealing bags, particularly constraining market competitiveness in large-scale production scenarios.

### SUMMARY

To address the deficiencies of the prior art, the present disclosure proposes a vacuum sealing bag structure that eliminates separate roll processing and lamination steps, significantly simplifying production flow and reducing manufacturing costs.

To achieve the above objective, the technical solution of the present disclosure provides a vacuum sealing bag, including:
a bag body, in which the bag body includes a wall body formed of plastic film, a bag mouth formed at a top of the wall body, and a bag bottom axially opposite to the bag mouth;
the wall body is a circumferentially closed continuous surface structure, and an inner surface thereof encloses to form a vacuum accommodation cavity;
the inner surface of the wall body is provided with a functional raised-and-depressed texture, wherein the raised-and-depressed texture extends continuously from the bag mouth along the inner surface of the wall body to the bag bottom to form a gas discharge path; and
the bag mouth is heat-sealable.

In some implementations, the bag bottom is any one of the following structures:
a) a heat-sealed closed bag bottom;
b) an open bag bottom.

In some implementations, the wall body is integrally formed by a blow molding process.

In some implementations, a raised shape of the raised-and-depressed texture is any one or a combination of a linear stripe, an oblique linear stripe, or a wavy pattern.

In some implementations, a raised height of the raised-and-depressed texture is in a range of 0.1 to 0.5 mm.

In some implementations, the raised shape of the raised-and-depressed texture is a linear stripe extending along an axial direction of the bag body.

In some implementations, the linear stripe has a width of 0.5 to 3 mm, and a spacing between adjacent textures is in a range of 0.5 to 5 mm.

In some implementations, a distribution area of the raised-and-depressed texture is any one of the following:
a) covering an entire region of the inner surface of the wall body (11);
b) covering 20% to 90% of the inner surface of the wall body (11), with a non-covered region being a smooth surface.

In some implementations, the plastic film has a thickness of 10 to 300 μm.

In some implementations, the plastic film is a single-layer structure made of polyethylene or polypropylene.

The present disclosure achieves beneficial effects through the following approaches, enabling substantial cost reduction:
1. Process flow simplification: The vacuum sealing bag structure of the present disclosure improves the conventional processes—including separate preparation of smooth films and raised-and-depressed texture films, cutting, lamination, and edge fusion—by enabling integral formation through a blow molding process, thereby streamlining the manufacturing procedure;
2. Edge waste reduction: The present process eliminates generation of cutting remnants, enhancing material utilization rate and minimizing waste.

### BRIEF DESCRIPTION OF THE DRAWINGS

FIG. 1 is a front view of a vacuum sealing bag of the prior art;

FIG. 2 is a perspective view of the vacuum sealing bag of the prior art;

FIG. 3 is a structural schematic diagram of a cross-sectional view A-A of the vacuum sealing bag of the prior art;

FIG. 4 is a structural schematic diagram of a vacuum sealing bag according to Embodiment 1 of the present disclosure;

FIG. 5 is a perspective view of the vacuum sealing bag according to Embodiment 1 of the present disclosure;

FIG. 6 is a structural schematic diagram of a cross-sectional view A-A of the vacuum sealing bag according to Embodiment 1 of the present disclosure;

FIG. 7 is a structural schematic diagram of a cross-sectional view B-B of the vacuum sealing bag according to Embodiment 1 of the present disclosure;

FIG. 8 is a schematic diagram showing a partial oblique linear stripe coverage pattern on an inner surface of a wall body of a vacuum sealing bag according to Embodiment 2 of the present disclosure;

FIG. 9 is a schematic diagram showing a partial wavy pattern coverage on an inner surface of a wall body of a vacuum sealing bag according to Embodiment 4 of the present disclosure;

FIG. 10 is a perspective view of a vacuum sealing bag according to Embodiment 5 of the present disclosure in an unfolded state;

FIG. 11 is a structural schematic diagram of the vacuum sealing bag according to Embodiment 5 of the present disclosure in a rolled material state;

FIG. 12 is a comparative diagram of fusion edge structures between the prior art and the vacuum sealing bags of the present disclosure (12a: prior art; 12b: Embodiment 1; 12c: Embodiment 5);

FIG. 13 is a flow chart of a blow molding process.

### LIST OF THE REFERENCE NUMERALS

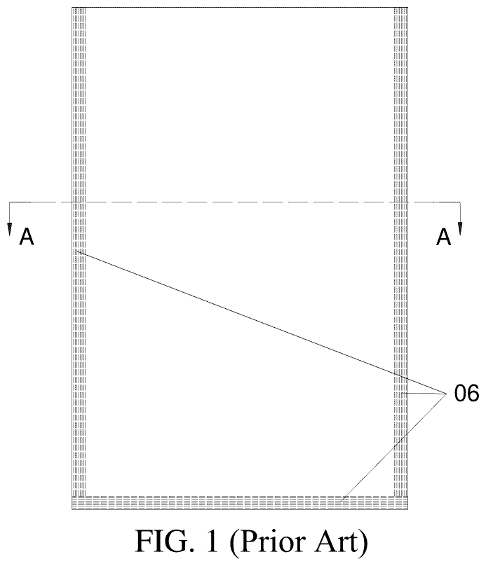

### FIGS. 1-3 (Prior Art)

Smooth plastic film layer 0111
Raised-and-depressed texture plastic film layer 0112
Raised-and-depressed texture 04
Fusion edge 06

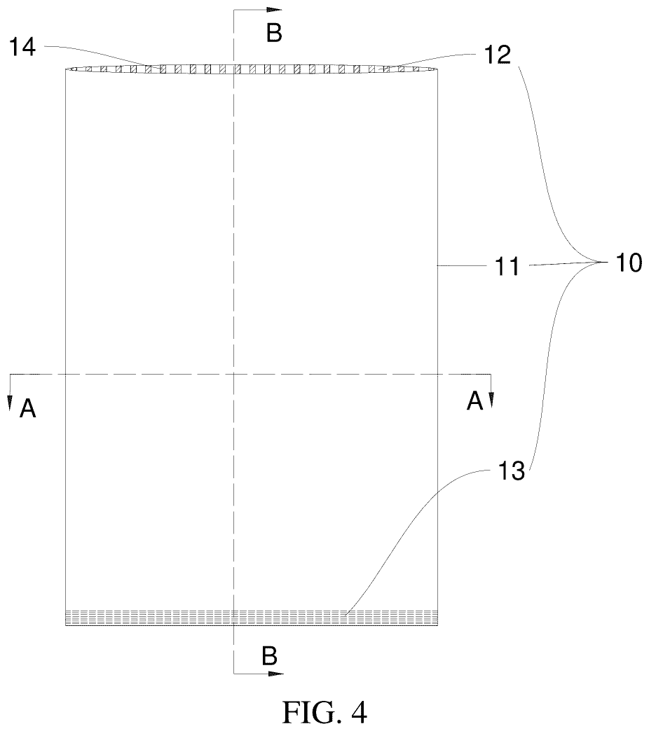

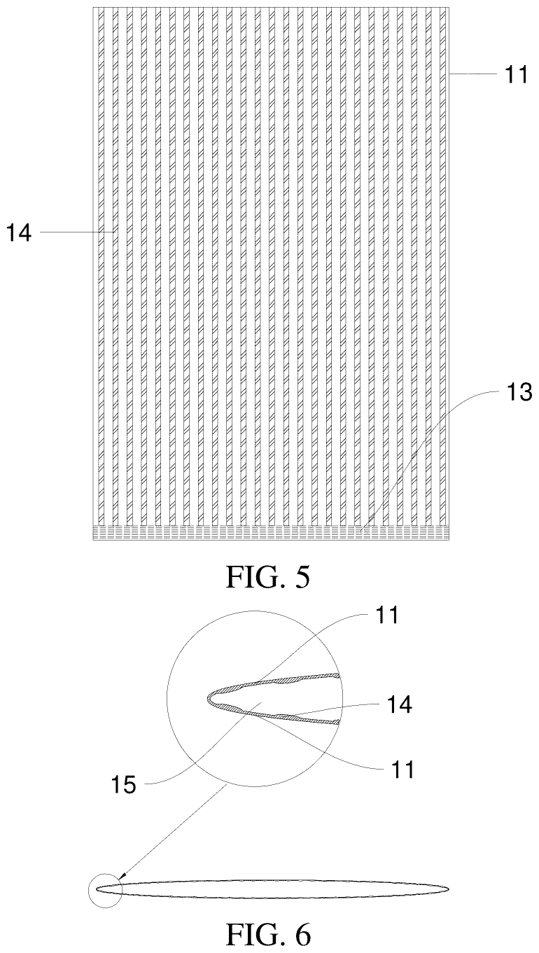

### FIGS. 4-12 (Present Disclosure)

Bag body 10
Wall body 11
Bag mouth 12
Bag bottom 13
Raised-and-depressed texture 14
Vacuum accommodation cavity 15

### DETAILED DESCRIPTION

The technical solutions in the embodiments of the present disclosure are clearly and completely described below in conjunction with the accompanying drawings of the present disclosure, but without limiting the scope of the present disclosure.

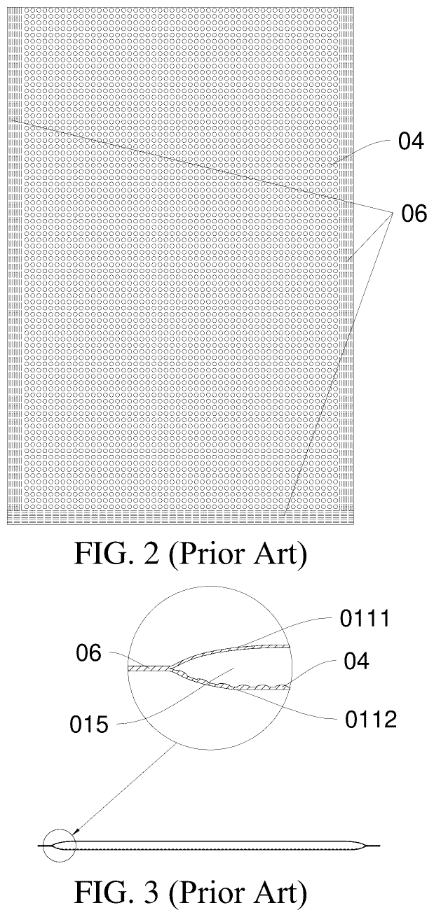

In the present disclosure, for better description, the following illustrations are made: the observer faces the accompanying FIG. 2 for observation, the left-rear side of the observer is set to front, the right-front side of the observer is set to rear, the left-front side of the observer is set to right, the right-rear side of the observer is set to left, the top side of the observer is set to top, and the bottom side of the observer is set to bottom. It should be noted that the terms “front,” “rear,” “upper,” “lower,” “interior,” “top,” “bottom,” and the like are used in the text to indicate orientation or positional relationships based on the accompanying drawings only for the purpose of facilitating a clear description of the present disclosure and are not intended to indicate or imply that the structures or parts referred to necessarily have a particular orientation or are constructed in a particular orientation and, therefore, are not to be construed as a limitation of the present disclosure. In addition, the related terms “first”, and “second”, if any, are used only for purposes of clarity or simplicity of description and are not to be construed as indicating or implying relative importance or quantity.

### Embodiment 1: Closed Vacuum Sealing Bag with Full-Area Linear Texture

1. Product Structure This embodiment provides a rectangular sheet-like vacuum sealing bag, as shown in FIGS. 4-7, including a bag body 10. The bag body 10 is integrally formed by blow molding linear low-density polyethylene (LLDPE), with overall dimensions of 300±5 mm (length)×200±3 mm (width).

The structure includes:
a wall body 11, having a thickness of 10 μm, the wall body 11 being a circumferentially closed continuous surface structure;
a bag mouth 12, formed at a top of the wall body 11;
a bag bottom 13, axially opposite to the bag mouth 12, being a heat-sealed closed bag bottom; and
a vacuum accommodation cavity 15, enclosed by the wall body 11 to form the vacuum accommodation cavity 15 of the sealing bag.

### 2. Surface Texture Design

The inner surface of the wall body 11 is provided with a functional raised-and-depressed texture 14, and the raised-and-depressed texture includes linear stripes extending along an axial direction of the bag body.

The linear stripes have dimensions of any one of the following:
a) Stripe raised height: 0.1 mm, stripe width: 0.5 mm, adjacent stripe spacing: 0.5 mm;
b) Stripe raised height: 0.5 mm, stripe width: 3 mm, adjacent stripe spacing: 5 mm;

Distribution: Covering the entire inner surface of the wall body.

### 3. Manufacturing Process

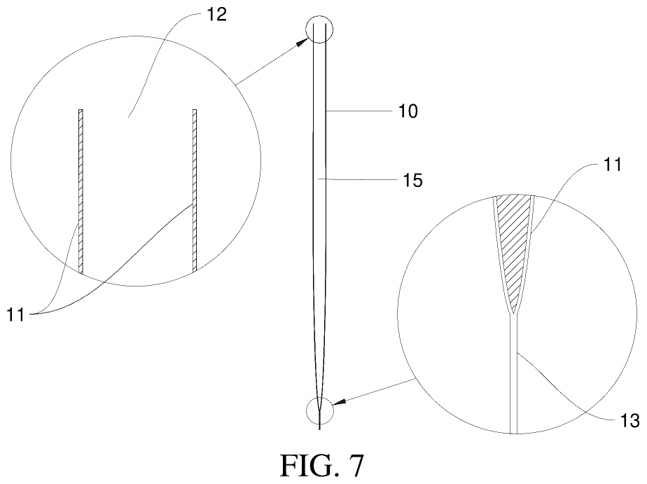

As shown in FIGS. 6 and 7, the manufacturing process of the vacuum sealing bag of the present disclosure includes the following steps:

Preform preparation: Employing a mature blow molding process using linear low-density polyethylene as raw material. A customized annular die is fabricated according to design requirements of the linear stripes, and a hollow continuous vacuum sealing bag preform is formed through continuous blow extrusion operations. After flattening, the preform maintains a stable width within 200±3 mm.

Preform cutting: The prepared vacuum sealing bag preform is cut into sections each having a length of 300±5 mm, obtaining sheet-like vacuum sealing bag preforms with dimensions of 300±5 mm (length)×200±3 mm (width).

Bag bottom sealing and bag mouth forming: an end of the sheet-like preform undergoes heat-sealing to form a secured bag bottom 13; an opposite end thereof remains open to form a user-accessible bag mouth 12.

### 4. Performance Test Data

Through performance testing, the vacuum sealing bag of this embodiment exhibits excellent heat-seal strength and tear resistance. The heat-seal strength meets industry standards, and the tear resistance satisfies usage requirements, ensuring reliability and durability of the sealing bag.

### 5. Technical Effect Analysis

As shown in FIG. 12 (12a: prior art; 12b: the present embodiment), compared with the prior art, the vacuum sealing bag of the present disclosure reduces fusion edges from three to one and enables direct single-film extrusion for the preform.
a) Process simplification: Prior art: five processes: secondary film extrusion (smooth plastic film layer and raised-and-depressed texture plastic film layer)→cutting→lamination→heat-sealing;

Present disclosure: three processes: single-film extrusion→cutting→heat-sealing.
b) Edge waste reduction:

Prior art: Generates approximately 10% edge waste during cutting;

Present disclosure: Edge waste approaches zero.

### Embodiment 2: Closed Vacuum Sealing Bag with Partial Oblique Linear Stripes

### 1. Product Structure

The vacuum sealing bag of this embodiment has the same structure as Embodiment 1, except that the material is changed to polypropylene (PP), and the wall body 11 has a thickness of 300 μm. The bag body 10 is integrally formed by a blow molding process, with dimensions of 300±5 mm (length)×200±3 mm (width), and is a circumferentially closed continuous surface structure. The inner surface encloses to form the vacuum accommodation cavity 15.

### 2. Surface Texture Design

The inner surface of the wall body 11 is provided with a functional raised-and-depressed texture 14, which is formed by oblique linear stripes. The oblique linear stripes have dimensions of either one of the following specifications:
a) Stripe raised height: 0.1 mm, stripe width: 0.5 mm, adjacent stripe spacing: 0.5 mm;
b) Stripe raised height: 0.5 mm, stripe width: 3 mm, adjacent stripe spacing: 5 mm;

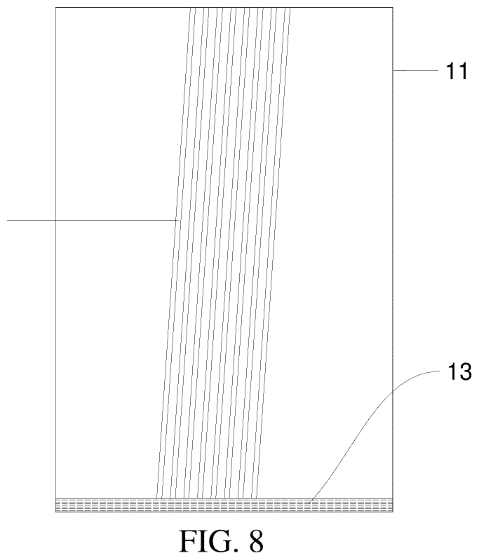

As shown in FIG. 8, the oblique linear stripes cover 20% of the inner surface of the wall body, with the remaining regions maintaining a smooth surface.

### 3. Manufacturing Process

The manufacturing process flow is substantially the same as that of Embodiment 1, except that during the preform preparation stage, a dedicated annular die is customized according to design requirements of the oblique linear stripes to ensure precise formation of the oblique linear stripes during blow molding. The preform cutting step and the bag bottom sealing and bag mouth forming steps are consistent with those of Embodiment 1.

### 4. Performance Test Data

Through performance testing, the vacuum sealing bag of this embodiment exhibits excellent heat-seal strength and tear resistance. The heat-seal strength meets industry standards, and the tear resistance satisfies usage requirements, ensuring reliability and durability of the sealing bag.

### 5. Technical Effect Analysis

This embodiment optimizes the performance of the sealing bag while simplifying the manufacturing process and reducing material waste by adopting polypropylene material and an oblique linear stripe design. The heat resistance and chemical stability of the polypropylene material enable the sealing bag to maintain reliable performance under various environmental conditions, thereby broadening its application scope.

### Embodiment 3: Closed Vacuum Sealing Bag with Partial Wavy Pattern

### 1. Product Structure

The vacuum sealing bag of this embodiment has the same structure as Embodiment 2, except for the raised-and-depressed texture design. The bag body 10 is made of polypropylene and integrally formed by a blow molding process, with dimensions of 300±5 mm (length)×200±3 mm (width). The wall body 11 has a thickness of 300 μm, forming a circumferentially closed continuous surface structure. The inner surface encloses to form the vacuum accommodation cavity 15.

### 2. Surface Texture Design

The inner surface of the wall body 11 is provided with a functional raised-and-depressed texture 14 employing a wavy pattern design. The wavy pattern parameters are as follows:
a) Wave height: 0.1 mm, wave width: 0.5 mm, with parallel-aligned waves having adjacent center-to-center spacing of 0.5 mm;
b) Wave height: 0.5 mm, wave width: 3 mm, with parallel-aligned waves having adjacent center-to-center spacing of 5 mm.

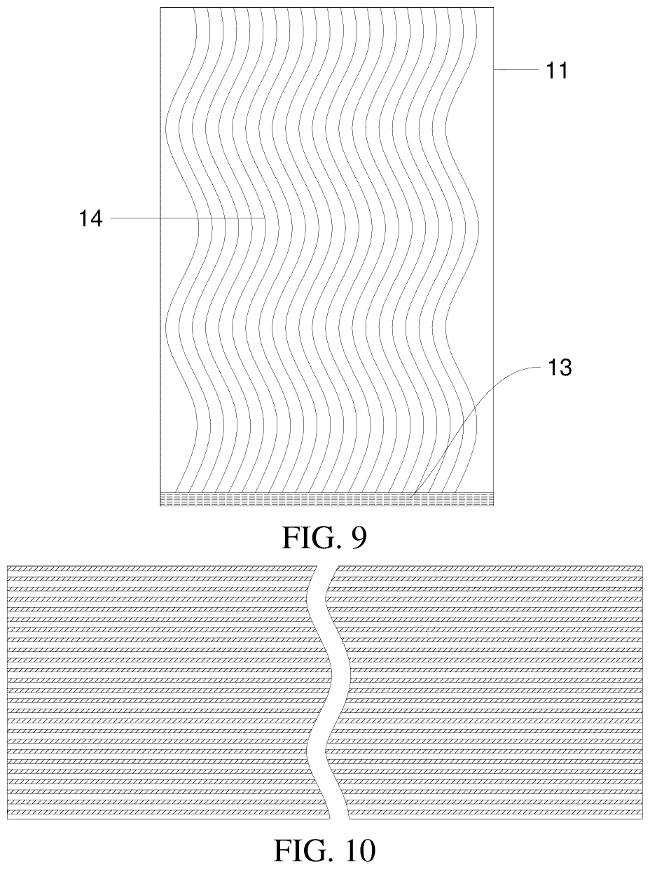

As shown in FIG. 9, the wavy pattern covers 90% of the inner surface of the wall body, with the remaining 10% of the area maintaining a smooth surface.

### 3. Manufacturing Process

The manufacturing process is substantially the same as that of Embodiment 2, except that during the preform preparation stage, a dedicated annular die is customized according to the design requirements of the wavy pattern to ensure precise formation of the wavy pattern during blow molding. The preform cutting step and the bag bottom sealing and bag mouth forming steps are consistent with those of Embodiment 2.

### 4. Performance Test Data

Through performance testing, the vacuum sealing bag of this embodiment exhibits excellent heat-seal strength and tear resistance. The heat-seal strength meets industry standards, and the tear resistance satisfies usage requirements, ensuring reliability and durability of the sealing bag.

### 5. Technical Effect Analysis

In some implementations, this embodiment optimizes the performance of the sealing bag while simplifying the manufacturing process and reducing material waste through the adoption of the wavy pattern design. The wavy pattern enhances the flexibility and compression resistance of the bag body.

### Embodiment 4: Roll-Type Vacuum Sealing Bag

### 1. Product Structure

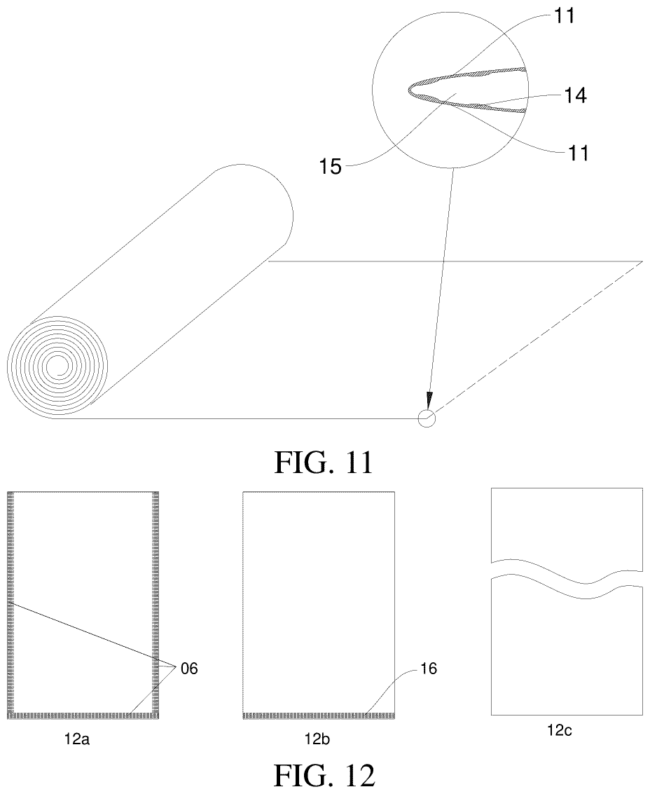

As shown in FIGS. 10-11, the vacuum sealing bag of this embodiment differs from Embodiment 1 primarily in the following aspects:

Employing an open bag bottom design, the length can be flexibly set according to actual user needs without fixed dimensional constraints.

The bag body 10 is integrally formed by blow molding linear low-density polyethylene into a continuous roll stock with a width of 200±3 mm.

### 2. Surface Texture Design

The inner surface of the wall body 11 is provided with a functional raised-and-depressed texture 14 composed of linear stripes. Stripe parameters:

The linear stripes have dimensions of any one of the following:
a) Stripe raised height: 0.1 mm, stripe width: 0.5 mm, adjacent stripe spacing: 0.5 mm;
b) Stripe raised height: 0.5 mm, stripe width: 3 mm, adjacent stripe spacing: 5 mm;

### 3. Manufacturing Process

Manufacturing process differences compared to Embodiment 1:

Preform preparation: A mature blow molding process is employed using linear low-density polyethylene as raw material. A customized annular die is fabricated according to the design requirements of the linear stripes, and a hollow continuous vacuum sealing bag preform is formed through continuous blow extrusion operations. After flattening, the preform maintains a stable width within 200±3 mm.

Preform forming: The preform is continuously extruded and cooled into a solidified roll stock, eliminating the cutting and fusion steps.

Roll stock winding: The formed preform is wound into rolls of desired lengths for storage and transportation.

### 4. Performance Test Data

Through performance testing, the roll-type vacuum sealing bag of this embodiment demonstrates excellent heat-seal strength and tear resistance. The heat-seal strength meets industry standards, and the tear resistance satisfies usage requirements, ensuring reliability and durability of the sealing bag.

### 5. Technical Effect Analysis

As shown in FIG. 12 (12a: prior art; 12c: this embodiment), compared with the prior art, the vacuum sealing bag of the present disclosure reduces fusion edges from three to zero and enables direct single-film extrusion for the preform.

This embodiment enhances production efficiency and product applicability while simplifying the manufacturing process and reducing material waste through the adoption of a roll-type design and an open bag bottom. The roll stock configuration facilitates large-scale production and continuous processing, and the open bag bottom design satisfies demands for rapid access and flexible length adjustment in specific scenarios. Compared with Embodiment 1, this embodiment retains the advantages of material utilization rate and process simplification while, in some implementations, further optimizes the sealing bag's functionality and performance, thereby expanding the product's application scope.

### Embodiment 5: Blow Molding Process for a Vacuum Sealing Bag

### 1. Process Overview

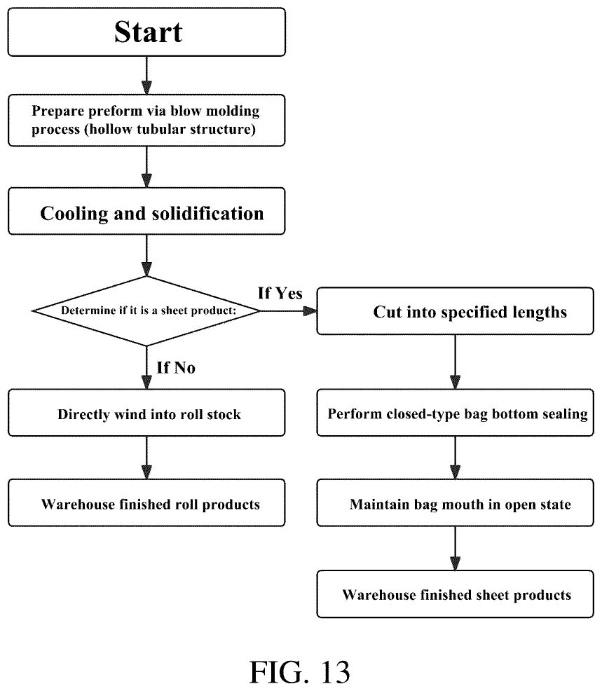

As shown in FIG. 13, this embodiment details a blow molding process for a vacuum sealing bag. Based on the design parameters of Embodiment 1, the process ensures high-quality and stable performance of the produced vacuum sealing bags by precisely controlling each process parameter.

### 2. Process Parameters and Steps

(a) Raw material preparation:

Linear low-density polyethylene is selected as the raw material, which exhibits excellent flexibility, strength, and processability to meet the performance requirements of vacuum sealing bags.
(b) Die design:

A customized annular die is fabricated according to the linear stripe design requirements in Embodiment 1. The die design ensures formation of continuous and uniform linear stripe raised-and-depressed textures during film blowing. The specific parameters are as follows:

Stripe raised height: 0.1 mm

Stripe width: 0.5 mm

Adjacent stripe spacing: 0.5 mm
(c) Extrusion and blowing:

The raw material is heated to an optimal temperature via a screw extruder for melting and plasticization.

The molten plastic is extruded through the die to form a hollow tubular preform.

During extrusion, compressed air is injected to blow the preform, causing expansion and cooling solidification.
(d) Cooling and haul-off:

The preform passes through a cooling device, typically employing air ring cooling, to rapidly cool it to room temperature.

The cooled preform is hauled off by a haul-off unit to control its moving speed, ensuring uniform cooling and solidification.
(e) Winding:

The cooled and solidified preform is wound into roll stock for subsequent cutting and processing. During winding, flatness and uniform tension of the preform should be maintained to prevent wrinkles or slackness.

### 3. Key Quality Control Points

Material quality: Ensure the purity and performance of linear low-density polyethylene raw materials meet specifications, avoiding impacts of impurities or substandard materials on product quality.

Temperature control: Precisely regulate temperatures of the extruder and die to guarantee proper melt fluidity and processability of the plastic.

Blow-up ratio: Appropriately control the blow-up ratio to enable full expansion of the preform during blowing and achieve uniform wall thickness.

Cooling effectiveness: Maintain consistent air flow rate and velocity in the cooling device to ensure rapid and uniform cooling of the preform, preventing performance degradation due to insufficient cooling.

Haul-off speed: Adjust the haul-off speed based on preform cooling and solidification status to ensure dimensional stability and surface quality.

### 4. Performance Testing and Application Validation

Performance testing is conducted on the produced vacuum sealing bags, including heat-seal strength, tear resistance, and gas barrier properties, to ensure compliance with relevant standards and usage requirements.

The sealing bag's performance is validated in practical applications through vacuum evacuation and heat-sealing operations on vacuum packaging machines, with verification of sealing integrity and reliability.

Through the aforementioned blow molding process, vacuum sealing bags meeting the design requirements of Embodiment 1 may be manufactured. These bags exhibit excellent sealing performance, mechanical strength, and gas barrier properties, making them suitable for vacuum packaging of food, pharmaceutical products, and other items.

The above described are only some implementations of the present disclosure. It should be noted that for those skilled in the art, a plurality of improvements and modifications may be made without departing from the principles of the present disclosure, which should also application considered as the scope of protection of the present disclosure.

1. A vacuum sealing bag, comprising: a bag body, wherein the bag body comprises a wall body formed of plastic film, a bag mouth formed at a top of the wall body, and a bag bottom axially opposite to the bag mouth; the wall body is a circumferentially closed continuous surface structure, and an inner surface thereof encloses to form a vacuum accommodation cavity; the inner surface of the wall body is provided with a functional raised-and-depressed texture, wherein the raised-and-depressed texture extends continuously from the bag mouth along the inner surface of the wall body to the bag bottom to form a gas discharge path; and the bag mouth is heat-sealable, wherein the wall body is integrally formed by a blow molding process, and a raised shape of the raised-and-depressed texture is any one or a combination of a linear stripe, an oblique linear stripe, or a wavy pattern.

2. The vacuum sealing bag according to claim 1, wherein the bag bottom is any one of the following structures: a) a heat-sealed closed bag bottom; b) an open bag bottom.

3. (canceled)

4. (canceled)

5. The vacuum sealing bag according to claim 1, wherein a raised height of the raised-and-depressed texture is in a range of 0.1 to 0.5 mm.

6. The vacuum sealing bag according to claim 2, wherein a raised height of the raised-and-depressed texture is in a range of 0.1 to 0.5 mm.

7. (canceled)

8. (canceled)

9. The vacuum sealing bag according to claim 5, wherein a raised shape of the raised-and-depressed texture is a linear stripe extending along an axial direction of the bag body.

10. The vacuum sealing bag according to claim 6, wherein a raised shape of the raised-and-depressed texture is a linear stripe extending along an axial direction of the bag body.

11. (canceled)

12. (canceled)

13. The vacuum sealing bag according to claim 9, wherein the linear stripe has a width of 0.5 to 3 mm, and a spacing between adjacent textures is in a range of 0.5 to 5 mm.

14. The vacuum sealing bag according to claim 10, wherein the linear stripe has a width of 0.5 to 3 mm, and a spacing between adjacent textures is in a range of 0.5 to 5 mm.

15. (canceled)

16. (canceled)

17. The vacuum sealing bag according to claim 1, wherein a distribution area of the raised-and-depressed texture is any one of the following: a) covering an entire region of the inner surface of the wall body; b) covering 20% to 90% of the inner surface of the wall body, with a non-covered region being a smooth surface.

18. The vacuum sealing bag according to claim 1, wherein the plastic film has a thickness of 10 to 300 um.

19. The vacuum sealing bag according to claim 2, wherein the plastic film has a thickness of 10 to 300 um.

20. The vacuum sealing bag according to claim 1, wherein the plastic film is a single-layer structure made of polyethylene or polypropylene.
